(19) United States
(12) Patent Application Publication
(10) Pub. No.: US 2003/0068827 A1
(43) Pub. Date: Apr. 10, 2003

(54) Enhanced scattering membranes for improved sensitivity and signal-to-noise of optical chemical sensors, fiber optic oxygen sensor for real time respiration monitoring utilizing same, and method of using sensor

(75) Inventors: Michael J. Morris, Dunedin, FL (US); Mahmoud R. Shahriari, Palm Harbor, FL (US)

Correspondence Address: FOWLER WHITE BOGGS BANKER, P.A., 501 E. KENNEDY BOULEVARD, SUITE 1700, TAMPA, FL, 33602, US

(73) Assignee: Ocean Optics, Inc.

(21) Appl. No.: 10/264,738

(22) Filed: Oct. 4, 2002

Related U.S. Application Data
(60) Provisional application No. 60/327,253, filed on Oct. 5, 2001.

(51) Int. Cl. G01N 21/64; B29D 11/00

(52) U.S. Cl. 436/136; 264/1.7; 264/236; 422/82.07; 422/82.11; 436/68; 427/2.11

(57) ABSTRACT

This invention relates to the field of optical chemical sensors which utilize indicator molecules to detect a particular analyte in a sample, wherein the indicator molecules produce a detectable response when exposed to the particular analyte to which the indicator molecule is sensitive. Specifically, this invention relates to the use of a matrix embedded within a membrane, where the matrix enhances the scattering of light and serves as a support which provides superior mechanical strength. The invention also relates to methods of using the improved sensor in conjunction with fiber optic probes.

### CROSS-REFERENCE TO RELATED APPLICATION

The present application claims the benefit of previously filed co-pending Provisional Patent Application Serial No. 60/327,253, filed Oct. 5, 2001, and incorporates by reference the contents therein.

### FIELD OF THE INVENTION

This invention belongs to the field of optical chemical sensors. Specifically, it relates to sensors based on the absorbance and emission of light by an indicator molecule where the optical properties of the indicator molecule change in response to a particular analyte. These indicator molecules are immobilized in a transparent substance that is exposed to light, where the substance is typically a solid such as a sol-gel or a polymer. More specifically, the present invention relates to the improved performance of such sensors by utilizing techniques and elements to increase the scattering of light in the vicinity of the indicator molecules, thus enhancing the interaction of light with the indicator molecules. This enhanced interaction translates into higher signal to noise of the light measurement and therefore higher sensitivity of the sensors.

More specifically, this invention relates to the use of novel components in order to increase the scattering of light in the vicinity of the indicators. In one embodiment, there is disclosed a novel combination of membrane with an embedded matrix, in which the matrix both (1) provides physical support for the membrane that contains the indicator molecule in a location into which light may be conveniently steered, and from which light can be conveniently detected, and (2) enhances the scattering of light within that substance to increase the mean free path of the light through that membrane. This invention also relates to a new process for manufacturing such enhanced scattering membranes. Finally, this invention relates to sensors which utilize the enhanced scattering membrane in probes for applications such as real-time respiration monitoring.

### BACKGROUND OF THE INVENTION

Indicator Molecules

Chemical sensors are generally known for use in a wide variety of areas such as medicine, scientific research, industrial applications and the like. Fiber optic and electrochemical approaches are generally known for use in situations where it is desired to detect and/or measure the concentration of a parameter at a remote location without requiring electrical communication with the remote location. Structures, properties, functions and operational details of fiber optic chemical sensors can be found in U.S. Pat. No. 4,577,109 to Hirschfeld, U.S. Pat. No. 4,785,814 to Kane, and U.S. Pat. No. 4,842,783 to Blaylock, as well as Seitz, “Chemical Sensors Based on Fiber Optics,” Analytical Chemistry, Vol. 56, No. 1, January 1984, each of which is incorporated by reference herein.

More generally, luminophores have been used to facilitate optical sensing. As used herein, a “luminophore” is a chemical species which reacts to the presence of a substance to produce an optical result. A fluorophore is thus one type of luminophore. Another type of luminophore changes color in accordance with changes in the amount of a substance of interest. A sensor which utilizes this principle to detect pH and Co.sub.2 is disclosed in Weigl, Holobar, Trettnak, Klimant, Kraus, O'Leary, and Wolfbeis, Optical Triple Sensor for Measuring pH, Oxygen and Carbon Dioxide, 32 JOURNAL OF BIOTECHNOLOGY 127 (1994)

For oxygen sensors, a ruthenium-based compound or “ruthenium complex” has been used as the fluorophore to provide the requisite fluorescence. The use of ruthenium complexes in oxygen sensors has been described in the following publications: Hartman, Leiner and Lippitsch, Luminescence Quenching Behavior of an Oxygen Sensor Based on a Ru(II) Complex Dissolved in Polystyrene, 67 ANAL. CHEM. 88 (1995); Carraway, Demas, DeGraff, and Bacon, Photophysics and Photochemistry of Oxygen Sensors Based on Luminescent Transition-Metal Complexes, 63 ANAL. CHEM. 337 (1991); and Bacon and Demas, Determination of Oxygen Concentrations by Luminescence Quenching of a Polymer-Immobilized Transition-Metal Complex, 59 ANAL. CHEM. 2780 (1987). In addition to ruthenium complexes, other fluorophores have also been used to detect oxygen, as described in the following publications: Wolfbeis, Posch and Kroneis, Fiber Optical Fluorosensor for Determination of Halothan and/or Oxygen, 57 ANAL. CHEM. 2556 (1985); and Wolfbeis, Offenbacher, Kroneis and Marsoner, A Fast Responding Fluorescence Sensor for Oxygen, I MIKROCHIMICA ACTA EEWIEN! 153 (1984). U.S. Pat. Nos. 5,176,882 to Gray et al., 5,155,046 to Hui et al., and 4,861,727 to Hauenstein et al. also disclose various flourophores which may be used to detect oxygen.

Such indicator molecules are specific in their excitation and emission wavelengths. The fluorescent emission from an indicator molecule may be attenuated or enhanced by the local presence of the molecule being analyzed. For example, a tris(4,7-diphenyl-1,10-phenanthroline) ruthenium (II) perchlorate molecule particular for oxygen sensing is excited by shining light onto the substance at 460 nm (blue). The molecules' fluorescent emission immediately occurs at 620 nm (orange-red). However, the emission is quenched by the local presence of oxygen interacting with the indicator molecule, to cause the intensity of the fluorescence to be related to the ambient oxygen concentration. Consequently, the more oxygen that is present, the lower the emission intensity and vice-versa and when zero or no oxygen is present, the maximum fluorescent intensity of emitted light is present.

The quenching of the luminescence of an emitter at the end of an optical fiber has also been used in temperature sensors. For temperature probes the emitters are generally solid phosphors rather than an aromatic molecule embedded in plastic, since access by molecules from the environment is not desirable. Various methods have been used to measure the amount of quenching: (i) Quick et al. in U.S. Pat. No. 4,223,226 ratios the intensity at one wavelength of the emission against another; (ii) Quick et al. also proposes determining the length of time it takes for the signal to fall from one level to another; (iii) Samulski in U.S. Pat. No. 4,245,507 (reissued as U.S. Pat. No. Re. 31,832) proposes to measure quenching by determining the phase of the emitted life. In a patent for temperature sensing at the end of an optical fiber, Hirschfeld in U.S. Pat. No. 4,542,987 proposes, in addition to method (i), that (iv) emission lifetime be used to measure quenching and that (v) Raman scattered light can be used as a reference.

Compounds other than those containing ruthenium are also known. Eastwood and Gouterman (1970) noted generally with respect to Pd and Pt porphyrin complexes that their “relatively high emission yields and short triplet lifetimes . . . may make these systems useful as “. . . biological probes for the presence of oxygen.” More recently, Bacon and Demas in UK Patent Application No. 2,132,348A propose the use of, inter alia, porphyrin complexes of VO2+, Cu2+, Pt2+, Zn.sup.2+ and Pd2+or dimeric Rh, Pt, or Ir complexes for monitoring oxygen concentration by emission quenching of intensity or lifetime. Suitable ligands would reportedly be etioporphyrin, octaethylporphin, and porphin.

The fluorescence of the indicator molecules employed in the device described in U.S. Pat. No. 5,517,313 is modulated, e.g., attenuated or enhanced, by the local presence of the analyte. For example, the orange-red fluorescence of the complex, tris (4,7-diphenyl-1,10-phenanthroline) ruthenium (II) perchlorate is quenched by the local presence of oxygen. This complex can, therefore, advantageously be used as the indicator molecule of an oxygen sensor. Similarly, other indicator molecules whose fluorescence is affected by specific analytes are known.

Optical Sensing Devices

These fluorescent indicators described above have classically been used in fluorescence spectrophotometers. These instruments are designed to read fluorescence intensity and/or the decay time of fluorescence. The indicator molecules and samples are classically in a solution or liquid phase and are assayed in discrete measurements made on individual samples contained in cuvettes.

Fluorescence indicators trapped in a solid substance typically are deposited as a thin layer or a membrane on a fiber optic waveguide, the waveguide and trapped analyte forming a fiber optic sensor. The sensor is introduced to the sample in a manner such that the indicator will interact with the analyte. This interaction results in a change in optical properties, as discussed above, which change is probed and detected through the fiber optic waveguide by an optical detector. The optical detector can be a single photodetector with an optical filter, a spectrometer or any optical detection system capable of measuring light intensity or the change in light intensity through time. These optical properties of chemical sensor compositions typically involve changes in colors or in color intensities, or fluorescence intensity or fluorescence lifetime. In these types of sensors, it is possible to detect changes in the analytes being monitored at the tip of the fiber sensor by a detector which is located remotely to the sample, in order to thereby provide remote monitoring capabilities. In such systems, the amount of light reaching the detector will limit the sensitivity and signal to noise of the analyte measurement.

A second area of fluorescence sensor state-of-the-art is in fiber optic devices. These sensor devices allow miniaturization and remote sensing of specific analytes. The fluorescent indicator molecule is immobilized via mechanical or chemical means to one end of an optical fiber. To the opposite end of the fiber is attached a fiber coupler (Y shaped fiber) or a beam splitter. Incident excitation light is coupled into one leg of the fiber typically via a filter and a lens. Excitation light is carried via the fiber to the distal end where the fluorescent indicator molecule is immobilized to the tip.

Upon excitation, the indicator molecule uniformly radiates the fluorescent light, some of which is recaptured by the fiber tip and propagated back through the fiber to the Y junction or “coupler”. At the junction, a substantial portion (typically half) of the fluorescence is conveyed back to the emitter or point of origin thereby unavailable for signal detection. To offset the inefficiencies of the system, lasers are often used to raise the input power and highly sensitive photomultiplier tubes are used as detectors thereby raising costs by thousands of dollars. The other half travels along the other leg of the Y to the detector and is recorded.

U.S. Pat. No. 6,024,923 issued to Melendez, et al. on Feb. 15, 2000 entitled Integrated Fluorescence-Based Biochemical Sensor, discloses an integrated biochemical sensor for detecting the presence of one or more specific samples having a device platform with a light absorbing upper surface and input/output pins. An encapsulating housing provides an optical transmissive enclosure which covers the platform and has a layer of fluorescence chemistry on its outer surface. The fluorophore is chosen for its molecular properties in the presence of the sample analyte. The detector and light sources are all coupled to the platform and encapsulated within the housing. A filter element is used to block out unwanted light and increase the detector's ability to resolve wanted emission light.

U.S. Pat. No. 5,910,661 issued to Colvin, Jr. on Jun. 8, 1999 entitled Flourescence Sensing Device discloses a fluorescence sensing device for determining the presence or concentration of an analyte in a liquid or gaseous medium. The device is constructed of an optical filter, which is positioned on a photodetector and which has a thin film of analyte-permeable, permeable, fluorescent indicator molecule-containing material on its top surface. An edge-emitting, light-emitting P-N junction is positioned on the top surface of the optical filter such that the P-N junction from which light is emitted is positioned within the film. Light emitted by the fluorescent indicator molecules impacts the photodetector thereby generating an electrical signal that is related to the concentration of the analyte in the liquid or gaseous medium. Fluorescence sensing devices according to this invention are characterized by very compact sizes, fast response times and high signal-to-noise ratios.

U.S. Pat. No. 5,517,313, also issued to Colvin describes a fluorescence sensing device comprising a layered array of a fluorescent indicator molecule-containing substance, a high-pass filter and a photodetector. In this device, a light source, preferably a light-emitting diode (“LED”), is located at least partially within the indicator material, such that incident light from the light source causes the indicator molecules to fluoresce. The high-pass filter allows emitted light to reach the photodetector, while filtering out scattered incident light from the light source.

None of these devices, however, incorporate a scattering medium as is disclosed by the present invention.

Optical Sensors for Use in Detecting Oxygen:

Because oxygen is a triplet molecule, it is able to quench efficiently the fluorescence and phosphorescence of certain luminophores. This effect (first described by Kautsky in 1939) is called “dynamic fluorescence quenching.” Collision of an oxygen molecule with a fluorophore in its excited state leads to a non-radiative transfer of energy. The degree of quenching is related to the frequency of collisions, and therefore, to the concentration, pressure and temperature of the oxygen-containing media.

There are several issued patents that concern optical sensors designed to sense the presence of oxygen in addition to those devices described above.

An oxygen sensor based on oxygen-quenched fluorescence is described in U.S. Pat. Reissue No. 31,879 to Lubbers et al. Lubbers et al. describe an optrode consisting of a light-transmissive upper layer coupled to a light source, an oxygen-permeable lower diffusion membrane in contact with an oxygen-containing fluid, and a middle layer of an oxygen-quenchable fluorescent indicating substance, such as pyrenebutyric acid. When illuminated by a source light beam of a predetermined wavelength, the indicating substance emits a fluorescent beam of a wavelength different from the source beam and whose intensity is inversely proportional to the concentration of oxygen present. The resultant beam emanating from the optode, which includes both a portion of the source beam reflected from the optrode and the fluorescent beam emitted by the indicating substance, is discriminated by means of a filter so that only the fluorescent beam is sent to the detector. In a second embodiment, the optrode consists of a supporting foil made of a gas-diffusable material such as silicone in which the fluorescent indicating substance is randomly mixed, preferably in a polymerization type reaction, so that the indicating substance will not be washed away by the flow of blood over the optode.

U.S. Pat. No. 3,612,866 to Stevens describes a method of calibrating an oxygen-quenchable luminescent sensor. The Stevens device includes an oxygen-sensitive luminescent sensor made of pyrene and, disposed adjacent thereto, an oxygen-insensitive reference sensor also made of pyrene but which is covered with an oxygen-impermeable layer. The oxygen concentration is evaluated by comparing the outputs of the measuring and reference sensors.

Substances

Indicator molecules that are incorporated at the distal end of fiber optic sensors are often configured as membranes that are secured at the distal tip end of the waveguide device or optrode. The indicator-containing substance is typically spread as a thin layer or membrane for mechanical support. Sensors of this general type are useful in measuring gas concentrations such as oxygen and carbon dioxide, monitoring the pH of a fluid, and the like. Ion concentrations can also be detected, such as potassium, sodium, calcium and metal ions.

A typical fiber optic oxygen sensor positions the sensor material at a generally distal location with the assistance of various different support means. Support means must be such as to permit interaction between the oxygen indicator and the substance being subjected to monitoring, measurement and/or detection. With certain arrangements, it is desirable to incorporate membrane components into these types of devices. Such membrane components must possess certain properties in order to be particularly advantageous. Many membrane materials have some advantageous properties but also have shortcomings. Generally speaking, the materials must be selectively permeable to oxygen molecules, and of sufficient strength to permit maneuvering of the device without concern about damage to the oxygen sensor.

It is known that a luminescent aromatic molecule embedded in plastic is subject to quenching by oxygen present in the gas or liquid in contact with the plastic. This phenomenon was reported by Bergman (Nature 218:396, 1966), and a study of oxygen diffusion in plastic was reported by Shaw (Trans. Faraday Soc. 63:2181-2189, 1967). Stevens, in U.S. Pat. No. 3,612,866, ratios the luminescence intensities from luminescent materials dispersed in oxygen-permeable and oxygen-impermeable plastic films to determine oxygen concentration. Lubbers et al. in U.S. Pat. No. 4,003,707 proposed the possibility of positioning the emitting substance at the end of an optical fiber. Peterson et al. in U.S. Pat. No. 4,476,870 also employs the quenching of an emitting molecule in plastic at the end of an optical fiber. Both Lubbers and Peterson reference emission against scattered exciting light.

According to the invention disclosed in U.S. Pat. No. 6,015,715, a sensitive single-layer system is produced in such a way that the fluorescence indicators are adsorbed on to a filling material, and in connection therewith a mixture is produced with a material permeable to the analyte to be investigated. The mixture produced is then compressed under the action of pressure, advantageously at an applied pressure of 12 to 20×10⁴ Pa, preferably 15×10⁴ Pa on a substrate, the layer thickness being formed in dependence on the applied pressure used. The sensitive layer thus applied is polymerized, polycondensed or hardened, this preferably being carried out in an extrusion mould to be used. The layer is additionally homogenized by swelling in a fluorescence indicator solution.

In the sensor described in U.S. Pat. No. 5,517,313, the material which contains the indicator molecule is permeable to the analyte. Thus, the analyte, can diffuse into the material from the surrounding test medium, thereby affecting the fluorescence emitted by the indicator molecules. The light source, indicator molecule-containing material, high-pass filter and photodetector are configured such that at least a portion of the fluorescence emitted by the indicator molecules impacts the photodetector, generating an electrical signal which is indicative of the concentration of the analyte in the surrounding medium.

Another pO2 sensor probe utilizing an oxygen-sensitive fluorescent intermediate reagent is described in U.S. Pat. No. 4,476,870 to Peterson et al. The Peterson et al. probe includes two optical fibers ending in a jacket of porous polymer tubing. The tubing is packed with a fluorescent light-excitable dye adsorbed on a particulate polymeric support. The polymeric adsorbent is said to avoid the problem of humidity sensitivity found with inorganic adsorbents such as silica gel. The probe is calibrated by using a blue light illuminating signal and measuring both the intensity of the emitted fluorescent green signal and the intensity of the scattered blue illuminating signal. Again, it is difficult to miniaturize the Peterson et al. sensor tip wherein a porous particulate polymer is packed within an outer tubing.

Scattering Media

Emissions from fluorophores propagate in all directions. In clear media, only those emissions propagating toward the filter within the acceptance angle of the probe are detected. Many optical sensors utilize clear media, such as glass as a substrate, to support the analyte-containing membrane substance which is deposited as a thin layer on the substrate.

In EP 0 344 313 there is proposed a layer sequence on a transparent substrate. Similarly, DE 41 08 808 proposes an indicator-containing silicon membrane convexly spread on a transparent substrate. Likewise, DE 31 48 830 discloses a device for determining the oxygen concentration in gases, liquids and tissues, in which a single-size layer is present on a transparent carrier with a luminescent surface formed with an adhesive or glue layer.

In U.S. Pat. No. 6,254,831, issued to Barnard et. al, there is disclosed a novel detection layer which includes a luminescent material, reflective particulate materials, and a polymeric binder to support and hold together the luminescent material and the reflective particles. These substances are spread as a membrane on top of a clear substrate. Barnard discloses that the use of the reflective particles serves the function of acting as an internal light barrier in the detection layer, thus reducing the optical interaction with the sample in contact with the sensor or detection layer. The addition of the reflective particles also enhances the emission signal by reflecting excitation light, which may otherwise escape by transmittance into the sample, back into the luminescent material as well as reflecting the luminescent emission back through the support and towards the detector optics. Reflective particles are disclosed such as a pigment, including titanium dioxide, zinc oxide, antimony trioxide, barium sulfate, and magnesium oxide, although any particles having a highly efficient reflectance of the wavelengths of excitation and of emission of the luminescent material is appropriate to add to the layer. Barnard also discloses that it is important that there is minimal interference from the substrate itself, and typically the substrate is substantially transparent to the wavelengths of excitation and of emission of the luminescent material.

Despite the foregoing, there is still a need for a device which increases the detected fluorescence of the sensor and which provides enhanced mechanical support. The scattering enhanced membrane of the present invention provides a novel platform that uses a scattering matrix that serves the function of an embedded scattering element and an embedded substrate. The present invention increases the signal by increasing the mean path of excitation wavelength light and improving the signal strength of emission wavelength light. These improvements thus result in the increased interaction of excitation light with an immobilized transducer, higher signal to noise of the optical measurement and higher sensitivity of the sensor and improved mechanical properties.

### OBJECTS AND SUMMARY OF THE INVENTION

In view of the foregoing, it is readily apparent that the sensitivity of optical sensors is limited by the amount of light that can be collected and brought to the detector. It is an object of the present invention to provide an improvement in the performance of any sensor which uses indicator molecules by increasing the interaction of light with the indicators and improving the efficiency with which emitted light is brought to the detector. The novel enhanced scattering medium is comprised of any material which is a good scatterer of light and which acts as support for an indicator molecule-containing substance.

According to the preferred embodiment of the present invention, there is provided scattering matrix elements which comprise glass fibers, cellulose, cellulose acetate, nylon, or any other suitable matrix, along with the luminophore or indicator molecule contained within a substance. The present invention allows for thinner layers of substance that coat the fibers and pores of the enhanced scattering medium, and the substance thus surrounds the support rather than simply lying on top of the support. In addition to providing for increased scattering of light, the enhanced scattering medium of the present invention also serves as the support of the indicator-containing substance, and in doing so provides superior mechanical strength.

In addition, there is presently no known technique for directly monitoring oxygen in gases that are inhaled or exhaled in respiration. The enhanced scattering media resulting from this invention can be used as a platform for making a number of sensors for gases, dissolved gases or dissolved solutes with enhanced sensitivity and fast response time. It is an object of the present invention to allow for on-line real-time monitoring of oxygen during breathing, including breath-to-breath monitoring of oxygen. The present invention can provide health care professionals with another critical parameter for efficient patient management. Such real time oxygen monitoring in combination with other respiratory parameters will improve patient health and recovery in ICU/FEO2 (Fractional Expired Oxygen), CCU (Cardiac Care Unit), and Metabolic Exercise Stress Testing/FEO2 settings. Real time oxygen sensing is also of great importance in the fields of biochemistry, molecular biology, medicine, drugs and pharmaceuticals, environmental sensing and monitoring, such as NOx, CO2, CO, hydrocarbons and moisture sensing, as well as biosensing.

An example of one embodiment of the invention is the use of a glass fiber matrix for supporting the sol-gel membrane that contains an immobilized ruthenium compound. The fibers of this fiberglass filter pad or matrix are coated with and surrounded by the sol-gel membrane. The matrix can be attached to a fiber optic probe, or can be utilized by projecting light through space to measure samples inside of packages. The fluorescent intensity or fluorescence lifetime of the ruthenium compound is reduced or quenched by the presence of molecular oxygen. The high scattering of the glass fibers and the high permeability of the enhanced scattering membrane make the sensor more sensitive and faster to respond to changes in the partial pressure of oxygen than sensors made using prior art. Because the new device monitors oxygen partial pressure on a real-time basis, it allows the monitoring of oxygen on a breath-by-breath basis and provides information as to the amount of oxygen consumed by the body.

### BRIEF DESCRIPTION OF THE DRAWINGS

These and other advantages of the invention may be more clearly understood with reference to the Specification and the drawings, in which:

FIG. 1—shows the concept of the scattering enhanced membrane.

FIG. 2—depicts the various components present in a preferred embodiment of the fiber optic sensor with enhanced scattering medium, including the probe, modulated light source, spectrometer and fiber optic cable.

FIG. 3—shows a layout of a probe according to the present invention, as seen along the longitudinal axis with the probe tip shown in partially expanded view.

FIG. 4—depicts an axial cross-section of a preferred embodiment of the sensing probe.

FIG. 5—shows a comparison of the excitation fluorescence and LED back reflection which result from a Ru-doped sol-gel membrane coated on (1) a fiber glass filter as taught by the present invention and (2) a standard glass filter of the prior art.

FIG. 6—shows a dynamic monitoring of oxygen during a normal breathing. The test subject is breathing atmospheric air (about 21% O2) at rest. Exhaled air has oxygen concentration of about 16.5%. Note that the fine structures during the exhalation (cardiogenic oscillations) are synchronous with subject's heartbeat. It is evident that the probe has both the sensitivity and response rate required to characterize the respiratory function.

### DETAILED DESCRIPTION OF THE INVENTION

1. Substances Containing Indicator Molecules

The fiber optic sensor elements of a preferred embodiment of the present invention employ the sol-gel technique to encapsulate fluorescence material sensitive to oxygen. The sol gel technique is well known in the art. An explanation of the usual process is contained in “Solgel Coating-based Fiber Optic O2/DO sensor,” M. R. Shahriari, J. Y. Dings, J. Tongs, G. H. Sigel, International Symposium on Optical Tools for Manufacturing and Advanced Automation, Chemical, Biomedical, and Environmental Fiber Sensors, Proc. SPIE, V01. 2068 (1993).

There are various routes to the manufacture of sol-gel matrices which are known to the art. Common starting materials are tetraethyl orthosilicate (TEOS) and tetramethy orthosilicate (TMOS). A common route is to mix the metal siloxane and solvent with any desired modifiers and/or dopants. This sol is then encouraged to form a gel via hydrolysis with subsequent polycondensation forming certain intermediate silicate fractals, monomers, and ultimately a rigid gel structure with high porosity.

During the manufacture of the sol-gel membrane, the indicator molecules are added. In making the preferred embodiment, a ruthenium complex (i.e., tris (4,7-diphenyl-1,10phenanthroline) ruthenium (II) perchlorate molecule) is added to the solution and dispersed via mixing prior to gel formation. We have found that vigorous mixing of the sol gel and ruthenium disperses the ruthenium throughout the sol-gel material appropriately.

Although a sol-gel membrane of the preferred embodiment yields the most sensitive sensor, the present invention should not be limited to sensors which use the sol-gel as disclosed above. Rather, the present invention can be utilized with sensors that contain organic polymer substances or any other substance as are appropriate for use with the techniques provided herein. Examples include substances including, but not limited to, polymeric materials such as poly(styrenes), poly(esters), poly(olefins), poly(acrylates), poly(alkylacrylates), poly(nitriles), poly(vinyl chlorides), poly(dienes), poly(carbonates), poly(siloxanes), poly(urethanes); and hetero polymeric combinations thereof, including methacrylate polymer or copolymer and ethylhexylmethacrylate and methylmethacrylate.

2. Scattering Enhanced Matrices

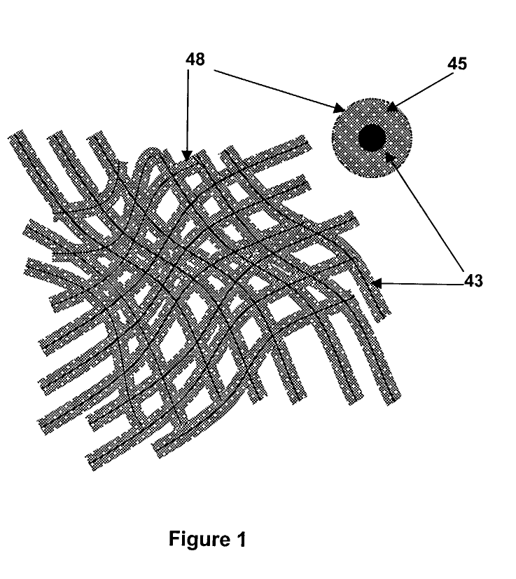

Referring now to FIG. 1, it can be seen that in the preferred embodiment of the present invention, the indicator molecules 48 are immobilized in a transparent substance 45 such as a polymer or sol-gel. The transparent substance coats the fibers and strands of the scattering matrix 43 yielding very thin membranes covering an embedded matrix which aids in scattering light and providing mechanical strength. When used in conjunction with a fiber optic probe, as seen in FIG. 3, the scattering enhanced membrane 43 thus serves as a scattering medium as well as a support mechanism which is capable of supporting the indicator molecule-containing substance in the path of the excitation light as well as the emission light detector.

The reflective matrix 43 of the preferred embodiment is Type A/E Glass Fiber Filter 25 mm. Lot # 81872, obtained from Gelman Sciences. As shown by FIG. 3, the glass fiber filter is affixed to the tip of the fiber optic probe 40 by mechanical pressure exerted by the threaded screw cap 44. Other glass fiber filters with different thickness and sizes can be obtained from other vendors and will fall within the spirit and scope of the present invention. It is to be noted that any such fibers should contain a surface which is conducive to the internal reflection of light. According to the present invention, scattering matrix elements may also comprise glass fibers, cellulose, cellulose acetate, nylon, or any other suitable reflective surface.

The scattering enhanced membrane 43 acts to minimize lost light by randomly scattering the light throughout the membrane, thus making emission light more available for detection. The use of a glass fiber filter thus allows the real time response as well as high sensitivity due to the scattering of light in the glass fiber filter. The high scattering medium and high permeability of the membrane makes the oxygen sensor highly sensitive, fast, and provides a fiber optic probe system with an improved signal-to-noise ratio.

The substance containing the indicator molecule is then affixed to the scattering matrix. Specifically, after the optical indicator is added to the sol-gel matrix, as described in the previous section, the resulting mixture is coated onto the fibers of the glass matrix. This is accomplished by soaking the glass fiber filter in the sol-gel monomers, removing excess monomers by blotting so that a thin layer surrounds each fiber in the matrix but without filling the interstitial spaces, and by allowing the monomers to finish polymerization by the removal of solvent through air drying. After coating, the sol-gel is cured and aged. The solvent, an alcohol which is typically ethanol or methanol, is removed by drying the forming gel. In the preferred method, the semi-rigid gel structure is then heated to temperatures between 80° and 90° Centigrade. The resultant metal oxide xerogel is highly porous and contains the ruthenium compound additive trapped within the membrane. The gel is more porous using an acid catalyzed polymerization than a base catalyzed system. Using a caustic to form the gel typically results in a powder or agglomerations rather than a contiguous film or monolith.

3. Fiber Optic Probe System Using Enhanced Scattering Media

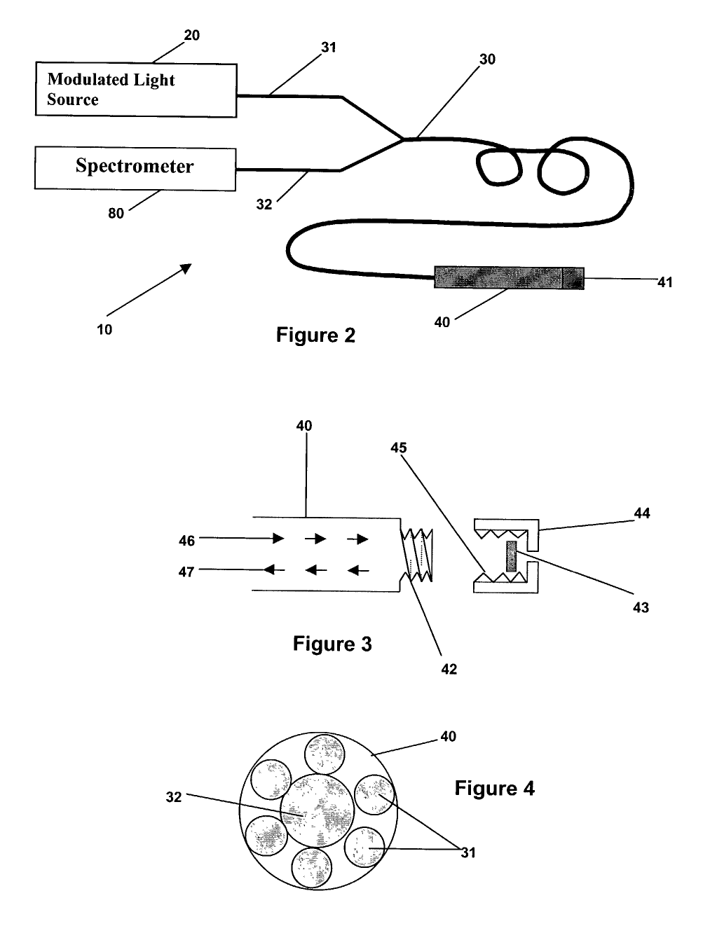

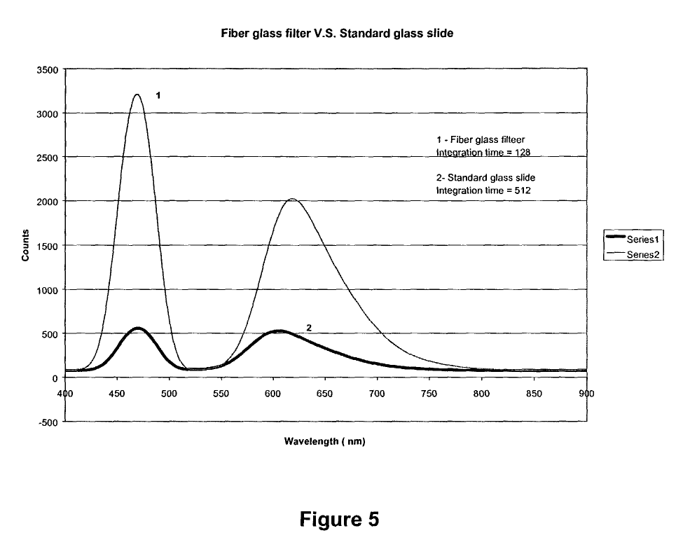

Referring now to FIG. 2, the preferred embodiment of the present fiber optic probe system is shown and denoted generally as 10. System 10 generally includes a modulated or constant light source 20, a bifurcated fiber 30, a probe 40 with probe tip 41, and a spectrometer CCD detector, time resolved fluorescence detector and high pass optical filter or intensity fluorescence detector with high pass filter 80.

Light source 20 can be any device capable of producing excitation light sufficient to cause detectable emission of a luminophore. In the preferred embodiment, a device capable of generating and emitting blue LED at a peak output of 470 nm is used. In the preferred embodiment, the light source 20 is an Ocean Optics LS-450 blue LED.

As shown in FIG. 4, bifurcated fiber 30 is further comprised of one or more excitation transmitting fibers 31 and one or more fluorescence receiving fibers 32. Excitation transmitting fibers 31 are connected at one end to light source 20, and at the other end to tip 41 of probe 40. In the preferred embodiment, fluorescence receiving fiber 32 is connected at one end to the tip 41 of probe 40 and at the other end to spectrometer CCD detector 80.

Referring again to FIG. 3, the general schematic layout of probe 40 is depicted as seen along the longitudinal axis. Probe 40 is a standard Ocean Optics reflective film probe. In the preferred embodiment, probe 40 includes a bundle of six excitation fibers 31 surrounding one fluorescence receiving fibers 32. The six excitation fibers are connected to the light source 20. The single fluorescence receiving fiber 32 is connected to the spectrometer. In the preferred embodiment the tip 41 of the probe 40 is equipped with external threads 42 to secure internal threads 45 on cap 44 designed to hold the oxygen sensitive glass fiber matrix 43 tight against the probe tip. Located between cap 44 and probe tip 41 is fiber glass matrix 43 coated with a sol-gel material doped with a fluorescence ruthenium compound as described herein (not depicted in FIG. 2). The open area in the center of the ring on cap 44 permits the sample to be analyzed to contact the enhanced scattering membrane 43. Those skilled in the art will recognize that there are many other ways to connect cap 44 to probe tip 41 which are within the spirit and scope of the present invention.

As shown in FIGS. 3-4, light 46 generated by modulated light source 20 travels into probe 40 and to probe tip 41. Excitation light 47 travels from probe tip 41 through fluorescent receiving fibers 32 to spectrometer CCD 80. Although the individual optic fibers are not shown in FIG. 2, it is to be understood that light is flowing through previously discussed cables.

In the preferred embodiment, the excitation transmitting fibers 31 are arranged around the periphery of fluorescence receiving fiber 32 in probe 40. FIG. 3 depicts the axial cross section of an exemplary embodiment of probe 40 in which six excitation transmitting fibers 31 and one fluorescence receiving fiber 32 are arranged in such a bundle. By surrounding the fluorescence receiving fiber 32 with multiple excitation transmitting fibers 31, the intensity of the fluorescence in the proximity of the receiving fiber is maximized. One skilled in the art will appreciate that a varying number of excitation transmitting fibers 31 can be used without deviating from the scope or spirit of this invention. Similarly, one skilled in the art will appreciate that a varying number of fluorescence receiving fibers 32, as well as the physical arrangement of all fibers, may be used without deviating from the scope or spirit of this invention. The limitation on the number of transmitting fibers that may be used with practical benefit is limited by the size of the light source, which limits the number that may be illuminated. Similarly, the number of receiving fibers that may used with practical benefits is limited by the area of the detector which can be coupled to the receiving fibers.

4. Operation of Fiber Optic Probe System

In addition to the earlier description of the various components, a general operational overview of an exemplary probe is insightful. The fiber optic probe system containing one embodiment of the present invention is operated by exposing probe tip 41 to the sample to be analyzed. Excitation light from the light source 20 is transmitted via excitation transmitting fiber 31 to the thin film of sol gel membrane 45 that coats the fibers of the glass fiber matrix 43 at probe tip 41. The glass fiber matrix acts to scatter the excitation light throughout the sol gel membrane, thus increasing the interaction between the excitation light and the ruthenium complex.

Fluorescence generated by the interaction of the excitation light 47 with the ruthenium compound 48 at probe tip 41 is reflected back to spectrometer CCD detector 80 via the fluorescence receiving fiber 32. When oxygen in the sample to be analyzed diffuses into the coating, it quenches the fluorescence. The degree of quenching correlates to oxygen pressure level. The oxygen measurement can be obtained in either a dry or wet gas environment. Thus, the fluorescence change due to the oxygen level variation of the test specimen is then monitored and correlated to oxygen partial pressure either visually or with the aid of a computer.

5. Performance of an Exemplary Probe Assembly

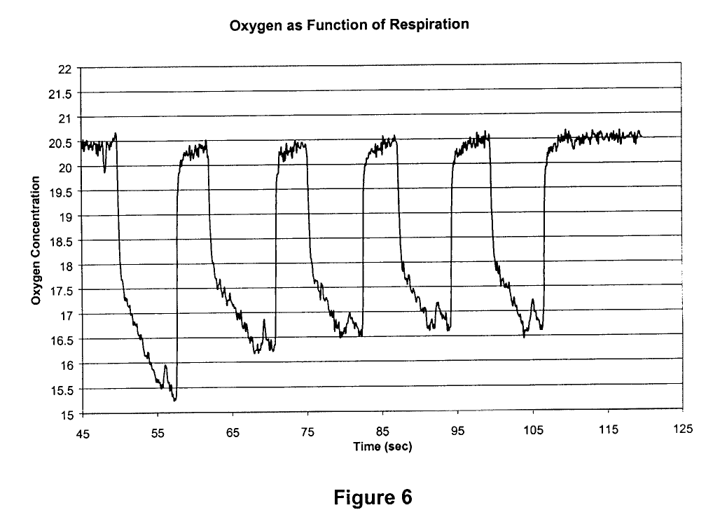

Samples of scattering enhanced membrane were prepared according to the present invention for experimental verification. In an experiment, we coated sol-gel membrane doped with ruthenium compound on a fiber glass filter as described above. The same sol-gel was also coated on a standard glass slide for comparison. Both samples were excited with a blue LED (470 nm). Both the excitation fluorescence and the emission fluorescence were transmitted via a bifurcated optical fiber and recorded. The graphical results are shown in FIG. 6, with the results of the probe employing a glass fiber filter depicted by the data labeled “1”, and the probe employing a standard glass slide depicted by the data labeled “2” and shown in bold. As shown in this figure, the excitation fluorescence and the emission fluorescence are enhanced by factors of 16 and 24 respectively as compared to the results of the standard glass slide.

The following is claimed:

1. A scattering enhanced medium for use in conjunction with a detector system of the type that detects the presence of analytes in a sample by emitting light to an indicator contained within a membrane and detecting the response of the indicator to the analyte, said medium comprising:
a matrix;
a membrane;
said matrix being embedded within said membrane;
said matrix causing light to scatter randomly within said membrane and thus cause interaction between the light and the indicator;
said matrix providing physical support for said membrane; and
where said matrix being positioned so as to be exposed to the light emitted from the system.

2. The scattering enhanced medium of claim 1, wherein said membrane is at least partially permeable by the analyte-containing sample.

3. The scattering enhanced medium of claim 1, wherein said matrix has a refractive index different from the refractive index of said membrane.

4. The scattering enhanced medium of claim 1, wherein said matrix is made of materials comprised of glass fiber filter, cellulose, cellulose acetate, nylon or any combination thereof.

5. A method of making an enhanced scattering medium utilizing a matrix and a solution of monomers which serves as a precursor to a membrane, comprising:
coating a reflective support with a solution of monomers;
blotting the reflective support so as to remove excess monomers; and
removing solvent from the solution through air drying and thus allowing the monomers to finish polymerization and thus form a membrane.

6. The method of claim 5, wherein said blotting step results in an enhanced scattering medium having a thin layer of monomers surrounding the component fibers of matrix, but where the monomer does not fill the interstitial spaces within the matrix.

7. The method of claim 5, wherein said removing step is followed by heating the enhanced scattering medium to above 70 degrees Centigrade.

8. A probe system for detecting the presence of an analyte in a sample, said probe system comprising:
a light emitting source;
a scattering enhanced medium;
said scattering enhanced medium being located in the path of light emitted from said light emitting source;
a substance;
an indicator;
said indicator being contained within said substance;
said scattering enhanced medium providing physical support for said substance;
said indicator emitting emission light when exposed to light emitted from said light emitting source;
said scattering enhanced medium causing said emission light to scatter, such scattering causing the interaction between the analyte and said indicator and thus causing said indicator to emit excitation light; and,
said excitation light being modified by the presence of the analyte.

9. A fiber optic probe system that detects the presence or amount of an analyte contained within a sample by exposing the analyte-containing sample to a fluorophore and detecting the quenching of the fluorophore by the analyte, comprising:
a light source;
a probe;
one or more excitation transmitting fibers;
said one or more excitation transmitting fibers optically connecting said light and said probe;
a light detector;
one or more fluorescence receiving fibers;
said one or more fluorescence receiving fibers optically connecting said light detector and said probe;
a sol gel substance;
a ruthenium compound;
said ruthenium compound being immobilized within said sol gel substance;
a glass fiber matrix;
said glass fiber matrix being embedded within said substance;
said glass fiber matrix being positioned so as to allow said ruthenium compound to be exposed to the light emitted from said light source through said excitation transmitting fibers;
said glass fiber matrix further being positioned so as to cause said ruthenium compound to be exposed to the analyte-containing sample; and,
said one or more fluorescence receiving fibers being positioned so as to expose said light detector to the excitation light emitted by said ruthenium compounds.

10. The system of claim 9 where the analyte to be detected is oxygen;

11. The process of detecting the presence of an analyte in a sample, comprising the steps of:
exposing a ruthenium complex contained within a sol gel membrane to light having a frequency which will cause excitation of the ruthenium complex, where the sol gel membrane is positioned on a matrix which causes light to scatter;
exposing the matrix to the sample while detecting the intensity of the excitation light emitted by the ruthenium complex; and, correlating the intensity of the excitation light detected to the presence of the analyte.

12. The process of claim 11 where the analyte to be detected is oxygen.

13. The process of claim 12 where the oxygen is detected in real-time.
